(19) United States
(12) Patent Application Publication
(10) Pub. No.: US 2022/0091258 A1
(43) Pub. Date: Mar. 24, 2022

(54) MONITORING VEHICLE LOCATION USING SURFACE-PENETRATING RADAR SYSTEMS AND BROADCAST TRANSMISSION

(71) Applicant: WaveSense, Inc., Somerville, MA (US)

(72) Inventors: John CLARK, Merrimack, NH (US); Connor QUINN, Somerville, MA (US); Sanford FREEDMAN, Chelmsford, MA (US); Byron STANLEY, Newton, MA (US)

(73) Assignee: WaveSense, Inc., Somerville, MA (US)

(21) Appl. No.: 17/473,004

(22) Filed: Sep. 13, 2021

Related U.S. Application Data
(60) Provisional application No. 63/080,927, filed on Sep. 21, 2020.

(51) Int. Cl. G01S 13/88; G01S 13/931; G01S 13/86

(52) U.S. Cl. CPC G01S 13/885; G01S 13/931; G01S 2013/9316; G01S 2013/9327; G01S 13/86

(57) ABSTRACT

A location system utilizes a ground-penetrating radar (GPR) antenna array both to detect surface and subsurface road features as well as broadcast transmissions, which are used to improve localization. For example, the GPR antenna may pick up an AM or FM radio transmission or Wi-Fi signals, and may use these to calculate or refine the estimated position of the vehicle.

### CROSS-REFERENCE TO RELATED APPLICATION

This application claims priority to and the benefit of, and incorporates herein by reference in its entirety, U.S. Provisional Patent Application No. 63/080,927, filed on Sep. 21, 2020.

### FIELD OF THE INVENTION

The present invention relates, generally, to vehicle route planning and, more particularly, to vehicle route planning using surface-penetrating radar (SPR) systems.

### BACKGROUND

Various navigation systems have been developed to provide vehicle drivers with route planning between a specified originating location and a destination location. Generally, one or more routes are selected from a large database of roads. The navigation system typically includes one or more position-determining devices, such as a global positioning system (GPS) receiver, to indicate the current position of the vehicle relative to roads in the database. Conventionally, route planning is performed based on certain user-specified criteria, such as the shortest distance or fastest travel time. In off-road conditions, where vehicles are driven on unsurfaced roads or tracks—which may feature sand, gravel, mud, snow, rocks and other natural terrain—route planning utilizing conventional techniques remains challenging. For example, off-road travel may require specially equipped vehicles depending on the conditions and terrain; such considerations, however, are not taken into account by the conventional navigation techniques.

As described in U.S. Pat. No. 8,949,024, the entire disclosure of which is hereby incorporated by reference, SPR images of surface and subsurface features along a vehicle's path may be obtained and analyzed to localize the vehicle. In particular, a location may be established based on locations associated with previously acquired SPR images. For example, new SPR images may be compared with previously acquired SPR images by means of an image correlation or other suitable technique.

This approach can provide accurate location information and can derive velocity information. GPS systems, on the other hand, can report speed using two GPS points (locations) and the GPS receiver clock (which is very accurate, synchronizing regularly with the atomic clocks aboard GPS satellites). Accordingly, there is a need for techniques directed toward improving the accuracy of location information generated by SPR systems.

### SUMMARY

Embodiments of the present invention utilize a SPR system having a ground-penetrating radar (GPR) antenna array to detect broadcast transmissions, and use these to improve localization. For example, the GPR antenna may pick up an AM or FM radio transmission or Wi-Fi signals, and may use these to calculate the position of the vehicle.

Accordingly, in a first aspect, the invention relates to navigation system comprising, in various embodiments, a SPR system comprising a GPR antenna array configured to receive SPR signals and radio frequency (RF) signals; an image-generation module for processing signals from the SPR system into images including subsurface features; an RF reception module for extracting an RF signal from the SPR system; and a navigation system for determining a location based at least in part on the RF signal, the images generated by the image-generation module, and at least one reference SPR image.

The SPR system may be configured to, if a location of the RF transmitter is known, use a sensed power level of the extracted RF signal to estimate a distance from the RF transmitter; and verify or correct a location that is estimated based on a GPR map. In some embodiments, the GPR sensor array comprises a horizontal GPR sensor array comprising a plurality of antennas; the SPR system may be configured to, if the location of the RF transmitter is not known, monitor changes in a power level of the received RF signal over time as part of a map to estimate vehicle location, and estimate the directional origin of the RF signal based on differences in arrival times across at least some of the plurality of antennas.

In some embodiments, the system further comprises a radio antenna vertically displaced from the GPR antenna array, wherein differences in arrival times across the GPR antenna array are used to estimate the horizontal direction with respect to a location of the RF transmitter, and further wherein differences in arrival times between the GPR antenna array and the radio antenna are used to estimate the vertical direction with respect to the location of the RF transmitter.

In a second aspect, the invention pertains to a navigation method comprising, in various embodiments, receiving SPR signals and RF signals; processing the SPR signals into images including subsurface features; and determining a location based at least in part on the received RF signals, the images and a library of reference SPR images.

The method may further comprise, if a location of the RF transmitter is known, using the sensed power level of the received RF signals to estimate a distance from the RF transmitter; and verifying or correcting a location that is estimated based on a GPR map. In some embodiments, the method further comprises, if the location of the RF transmitter is not known, monitoring changes in a power level of the received RF signal over time as part of a map to estimate vehicle location; and estimating the directional origin of the RF signal based on differences in arrival times.

The method may, in various embodiments, comprise estimating the horizontal direction with respect to a location of the RF transmitter based on differences in RF signal arrival times across a GPR antenna array; and estimating the vertical direction with respect to the location of the RF transmitter based on differences in arrival times between the GPR antenna array and a radio antenna. The received RF signals may, for example, be used to provide a coarse location estimate and the SPR signals are used to refine the coarse estimate.

As used herein, the term “substantially” means ±10%, and in some embodiments, ±5%.Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

The foregoing and the following detailed description will be more readily understood when taken in conjunction with the drawings, in which:

FIG. 1A schematically illustrates an exemplary traveling vehicle including a location-monitoring system in accordance with embodiments of the invention.

FIG. 1B schematically illustrates an alternative configuration in which the antenna of the location-monitoring system is closer to or in contact with the surface of the road.

FIG. 2 schematically depicts an exemplary location-monitoring system in accordance with embodiments of the invention.

FIGS. 3A-3D schematically depict alternative architectures for the controller and and RF receiver modules of a location-monitoring system in accordance with embodiments of the invention.

FIG. 4 schematically illustrates operation of the controller of a location-monitoring system using broadcast-signal transmission processing.

### DETAILED DESCRIPTION

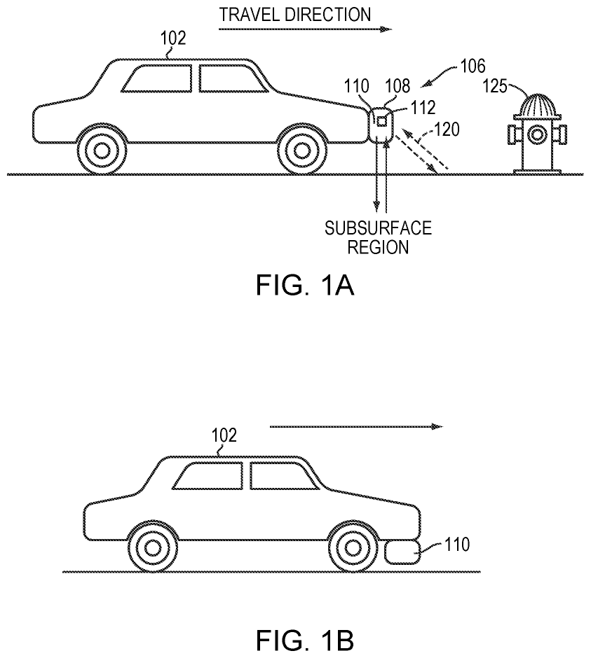

Refer first to FIG. 1A, which depicts an example vehicle 102 traveling on a predefined route 104; the vehicle 102 is provided with a terrain-monitoring system 106 for vehicle navigation in accordance herewith. In various embodiments, the terrain-monitoring system 106 includes an SPR system 108 having a ground-penetrating radar (GPR) antenna array 110 fixed to the front (or any suitable portion) of the vehicle 102. The GPR antenna array 110 is generally oriented parallel to the ground surface and extends perpendicular to the direction of travel. In an alternative configuration, the GPR antenna array 110 is closer to or in contact with the surface of the road (FIG. 1B). In one embodiment, the GPR antenna array 110 includes a linear configuration of spatially invariant antenna elements for transmitting GPR signals to the road; the GPR signals may propagate through the road surface into the subsurface region and be reflected in an upward direction. The reflected GPR signals can be detected by the receiving antenna elements in the GPR antenna array 110. In various embodiments, the detected GPR signals are then processed and analyzed to generate one or more SPR images (e.g., GPR images) of the subsurface region along the track of the vehicle 102. If the GPR antenna array 110 is not in contact with the surface, the strongest return signal received may be the reflection caused by the road surface. Thus, the SPR images may include surface data, i.e., data representing the interface of the subsurface region with air or the local environment.

For localization, the SPR images may be compared to SPR reference images that were previously acquired and stored (e.g., as a library) for subsurface regions that at least partially overlap the subsurface regions for the defined route. The image comparison may be a registration process based on, for example, correlation; see, e.g., the '024 patent mentioned above and U.S. Pat. No. 8,786,485, the entire disclosure of which is incorporated by reference herein. The location of the vehicle 102 can then be determined based on the comparison. Navigation requires searching a subset of the reference images to ascertain location, and reducing the size of this subset improves efficiency. An independent source of location information as provided herein reduces this subset, improving efficiency and reducing the chances of a false match. To reduce the frequency of image lookup, the vehicle 102 may be equipped with sensors that continuously record the orientation of the front wheels; in combination with odometer data, this may be used by the controller 112 to perform a “dead reckoning” estimate of current location based on a previous known location. The dead reckoning estimate may be further improved by comparing the current SPR image to one or more previously obtained SPR images as described in the '024 patent.

In addition, the location data determined based on comparison of the acquired SPR images and SPR reference images may be used to create a location map including the routes that the vehicle 102 has traveled. Additionally or alternatively, the location data for the vehicle 102 may be used in combination with the data provided by an existing map (e.g., GOOGLE map) and/or one or more other sensors or navigation systems, such as an inertial navigation system (INS), a GPS, a sound navigation and ranging (SONAR) system, a LIDAR system, a camera, an inertial measurement unit (IMU) and an auxiliary radar system, to guide the vehicle 102. For example, the controller 112 may localize the obtained SPR information to an existing map generated by the GPS. Approaches for utilizing the SPR system for vehicle navigation and localization are described in, for example, the '024 patent.

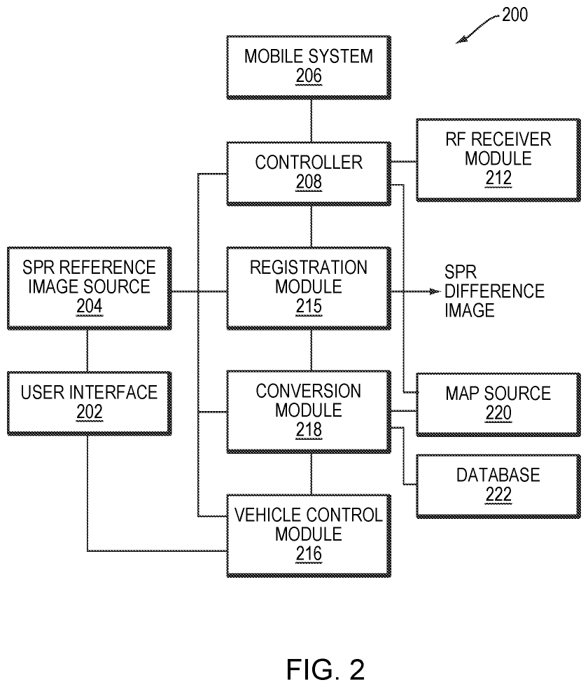

FIG. 2 depicts an example location-monitoring system 200 implemented in a vehicle for determining an optimal route in accordance herewith. To facilitate navigation, the SPR system 200 may include a user interface 202 through which a user can enter data to define a route, or select a predefined route. SPR images are retrieved from an SPR reference image source 204 according to the route. The SPR system 200 also includes a mobile SPR system 206 having an GPR antenna array 110 (see FIG. 1). The transmit operation of the mobile SPR system 206 is controlled by a controller (e.g., a processor) 208 that also receives the return SPR signals detected by the GPR antenna array 110. The mobile SPR system 206 generates SPR images of the subsurface region below the road surface and/or the road surface underneath the GPR antenna array 110 in accordance, for example, with the '024 and '485 patents mentioned above. The SPR image includes features representative of structure and objects within the subsurface region and/or on the road surface, such as rocks, roots, boulders, pipes, voids and soil layering, and other features indicative of variations in the soil or material properties in the subsurface/surface region. The controller 208 also includes or communicates with a radio frequency (RF) receiver module 212.

In various embodiments, a registration module 215 compares the SPR images provided by the module 210 to the SPR images retrieved from the SPR reference image source 204 to determine the location of the vehicle (e.g., the offset of the vehicle with respect to the closest point on the route). The locational information (e.g., offset data, or positional error data) determined in the registration process may be provided to a conversion module 218 that creates a location map for navigating the vehicle. For example, the conversion module 218 may generate GPS data corrected for the vehicle positional deviation from the route. Alternatively, the conversion module 218 may retrieve an existing map from a map source 220 (e.g., other navigation systems, such as GPS, or a mapping service), and then localize the obtained locational information to the existing map. In one embodiment, the location map of the predefined route is stored in a database 222 in system memory and/or a storage device accessible to the controller 208.

In some embodiments, the location of a signal received by the RF receiver module 212 may be derived from the signal frequency or content, and this may assist with localization of the vehicle. For example, if the frequency of the RF signal is known, the conversion module 218 may execute a simple look-up (locally or wirelessly via the internet) of FCC-licensed transmitters in the area. For example, if the vehicle is known (e.g., via modules 215, 218 based on the GPR map) to be traveling in Boston and a strong signal is detected at 98.5 MHz, the location of the WBZ transmitter can be looked up and the signal strength used to estimate the distance therefrom. Modern transmitters (digital TV, cellular, etc.) broadcast signals containing a digital bitstream that includes, in addition to data and telecommunication content, identification information. This information can tie a specific tower to its geographic location. The conversion module 218 may be configured to decode this bitstream and look up the location. The transmitter lookup may also obtain the power level of the transmitter, either from a publicly available source of such information or from a database assembled based on power levels sensed by and uploaded from vehicles equipped as described herein.

More generally, the RF receiver module 212 may receive AM or FM radio transmission or Wi-Fi signals from an RF transmitter, e.g., a broadcasting tower (for example, cellular (4G/GSM, etc.) or a Wi-Fi unit with a fixed or known location) using the GPR antenna array 110. If the location of the RF transmitter (and, in some cases, its power level) is known, the SPR system can use the sensed power level to estimate the distance from the RF transmitter, and thereby verify or correct the location estimated based on the GPR map.

Even if the RF transmitter's location is not known, the SPR system can monitor changes in the power level of the received radio (or other) signal over time (and, in some cases, across the sensors in the array) in conjunction with even an approximate map to better estimate vehicle location; the directional origin of the signal can be estimated based on the differences in arrival times across the antennas in the horizontal GPR sensor array. An automobile's conventional radio antenna, which may be vertically displaced from the GPR antenna array, can be employed to further estimate the location of the RF transmitter source. For example, differences in arrival times across the GPR antenna array may be used to estimate horizontal direction, and differences in arrival times between the GPR antenna array and the vehicle's radio antenna may be used to estimate vertical direction to the RF transmitter source. Alternatively, one or more other antennas can be vertically displaced from the GPR antenna array and used instead of or in addition to the vehicle's radio antenna.

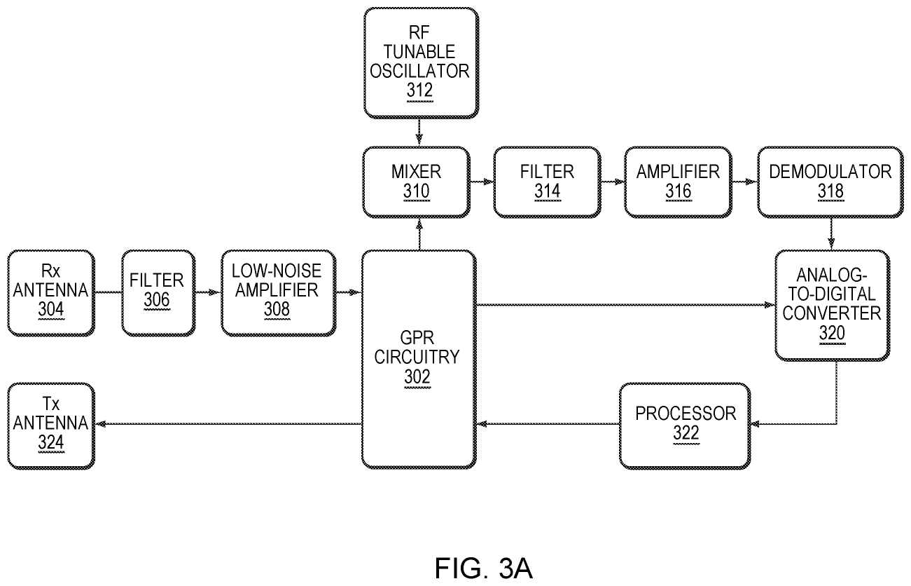

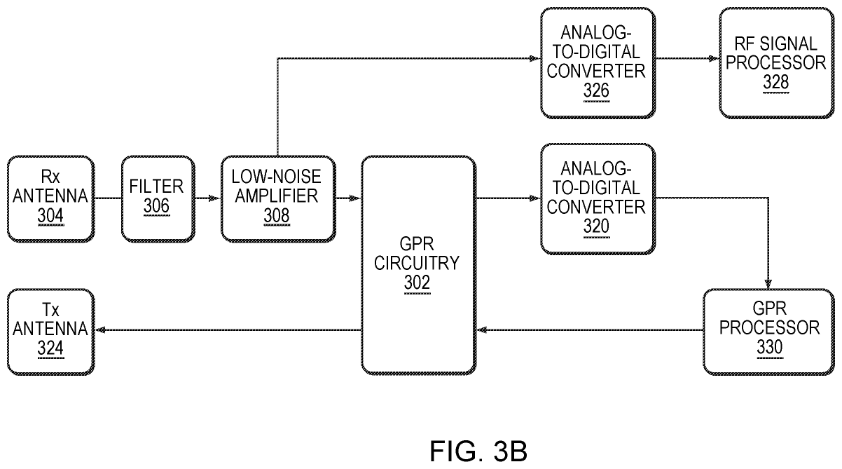

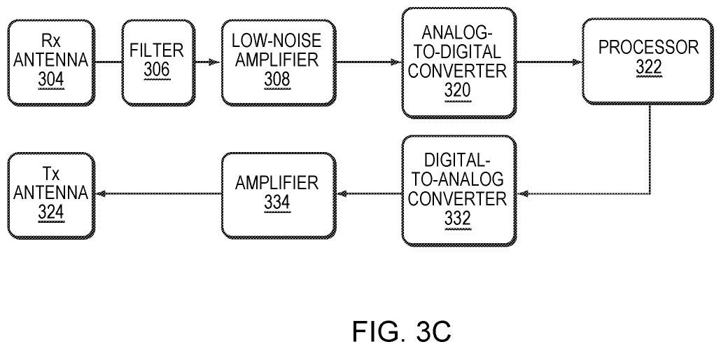

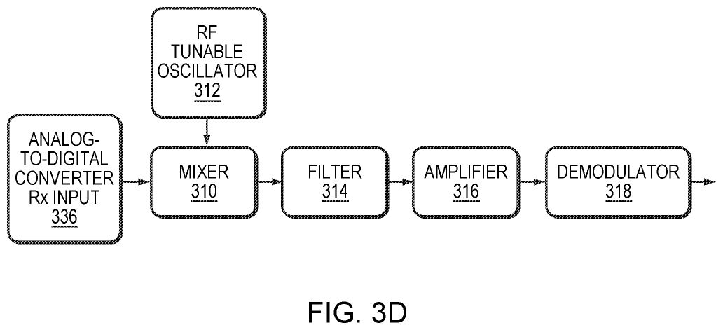

FIG. 3A shows an example of the controller 208 and RF receiver module 212 of FIG. 2. In FIG. 3A, the controller 208 (of FIG. 2) includes GPR circuitry 302 and a processor 322. The GPR antenna array 110 (of FIG. 1) receives a broadcast transmission signal, e.g., AM radio, FM radio, Wi-Fi, or another RF signal, via the reception (Rx) antenna 304, in addition to the reflected GPR signal that originated from Tx antenna 324. The raw signals are first processed by a first filter 306, which conditions the signal by removing spurious out-of-band signals, then by a low-noise amplifier 308. The GPR circuitry 302 receives an output from the low-noise amplifier 308 to process the reflected GPR signal. A mixer 310 also receives the low-noise amplified signal from the low-noise amplifier 308, acquires the desired broadcast transmission signal by mixing it with a signal from the RF tunable oscillator 312, and sends the output to a second filter 314, which further reduces spurious out-of-band signals. The second filter 314 outputs to an amplifier 316, which outputs to a demodulator 318. The amplifier 316 is conventional and any design offering reasonable linearity around the operating frequency range is suitable; it need not, for example, be a low-noise amplifier.

An analog-to-digital converter 320 receives the output from the demodulator, as well as from the GPR circuitry 302, and converts the analog signals from each into digital signals to be used by the processor 322. A transmission (Tx) antenna 324 is used by the GPR circuitry to send GPR signals for SPR processing. The Rx antenna 304 is also used by the GPR circuitry 302 to receive reflected GPR signals for SPR processing. The system of FIG. 3A may use, for example, a superheterodyne analog signal RF receiver with a generic mixed analog/digital GPR.

FIG. 3B shows another example of the controller 208 and RF receiver module 212 of FIG. 2. In FIG. 3B, the controller 208 (of FIG. 2) includes GPR circuitry 302 and a GPR processor 330. The GPR antenna array 110 (of FIG. 1) receives a broadcast transmission signal, e.g., AM radio, FM radio, Wi-Fi, or another RF signal, via the Rx antenna 304. The raw signal is first processed by a first filter 306, then by a low-noise amplifier 308. The GPR circuitry 302 receives an output from the low-noise amplifier 308. A first analog-to-digital converter 326 also receives the low-noise amplified signal from the low-noise amplifier 308 to convert the analog signal into a digital signal to be used by an RF processor 328. A second analog-to-digital converter 320 receives the output from the GPR circuitry 302 to convert the analog signal into a digital signal to be used by the GPR processor 330. A Tx antenna 324 is used by the GPR circuitry to send GPR signals for SPR processing. The Rx antenna 304 is also used by the GPR circuitry 302 to receive reflected GPR signals for SPR processing. The system of FIG. 3B may use, for example, a digital RF receiver with a mixed analog/digital GPR.

FIG. 3C illustrates another example of the controller 208 and RF receiver module 212 of FIG. 2. In FIG. 3C, the controller 208 (of FIG. 2) includes a processor 322. The GPR antenna array 110 (of FIG. 1) receives a broadcast transmission signal, e.g., AM radio, FM radio, Wi-Fi, or another RF signal, via the Rx antenna 304. The raw signal is first processed by a filter 306, then by a low-noise amplifier 308. An analog-to-digital converter 320 receives the low-noise amplified signal from the low-noise amplifier 308 to convert the analog signal into a digital signal to be used by a processor 322. The processor 322 outputs to a digital-to-analog converter 332 to convert the digital signal from the processor 322 into an analog signal that an amplifier 334 can amplify before sending the amplified signal to a Tx antenna 324. The Tx antenna 324 is used by the GPR circuitry to send GPR signals for SPR processing. The Rx antenna 304 is also used by the GPR circuitry 302 to receive reflected GPR signals for SPR processing. Relative to the embodiments shown in FIGS. 3A and 3B, the system of FIG. 3C represents simplified circuitry for a digital RF receiver with GPR.

FIG. 3D shows still another example of the controller 208 and RF receiver module 212 of FIG. 2. In FIG. 3D, processing for a digital superheterodyne RF receiver is illustrated. An analog-to-digital converter Rx input 336 receives an analog input from an Rx antenna 304 and converts it to a digital signal. A mixer 310 receives the digital signal from the analog-to-digital converter Rx input 336, mixes it with a signal from a RF tunable oscillator 312, and sends the output to a filter 314. The filter 314 outputs to an amplifier 316, which outputs to a demodulator 318. The downstream processing of the demodulator 318 of the FIG. 3D example may be similar to the demodulator 318 shown in FIG. 3A.

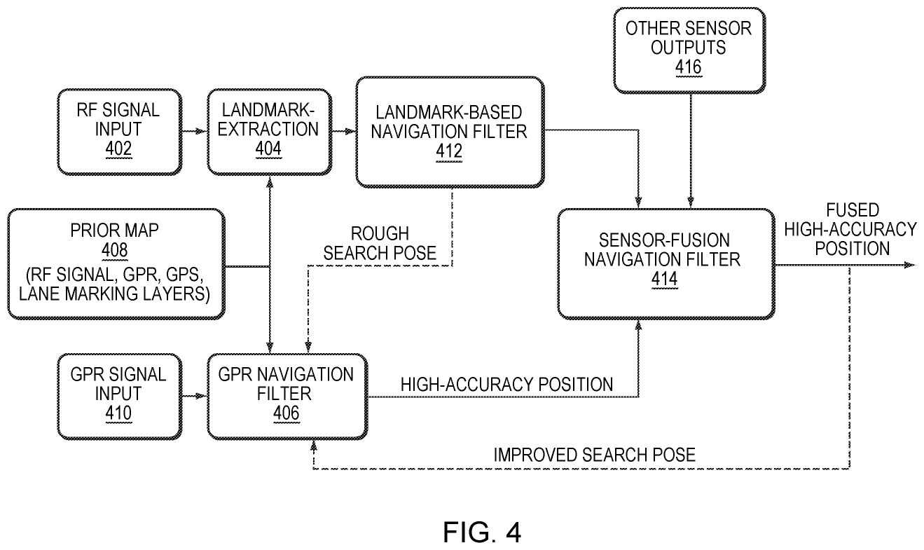

FIG. 4 shows an example of the operation of the controller 208 using broadcast-signal transmission processing. In. FIG. 4, an RF signal input 402 receives a processed signal from an RF processor, e.g., the processor 322 of FIGS. 3A and 3C or the GPR processor 330 of FIG. 3B. A landmark-extraction module 404 uses data from the RF signal input 402 to recognize landmarks (e.g., physical structures with known or previously catalogued locations—e.g., a fire hydrant 125 as shown in FIG. 1) near the determined positions of the broadcast location of the RF signal. The landmark-extraction module 404 may operate by storing the signatures of return signals associated with specific types of physical structures (fire hydrants, as noted, traffic signals, lampposts, signage, etc.) and analyzing the RF signal input 402 for approximate matches. The amplitude of a matching signature may be used to estimate distance to the landmark. Alternatively, a convolutional neural network programmed for object detection and recognition, as in a self-driving car, may be employed.

A GPR navigation filter 406 uses the landmarks determined from the landmark-extraction module 404, along with a prior map 408 and a GPR signal input 410—e.g., the GPR circuitry 302 of FIGS. 3A and 3B or the processor 322 of FIG. 3C—to provide navigation information. The prior map 408 may be or include previously stored information, such as locations of an RF signal, GPR information, GPS information, and lane-marking layers or similar information; essentially it is a signal source, location and power level map. It may be assembled, for example, by scraping data from the internet or government websites that list such information and made available for download on a server. Alternatively, it may be generated by uploading landmark data detected by many SPR-equipped vehicles as they drive around. The prior map 408 may be a stand-alone map or a layer in a navigation or self-driving vehicle map.

The landmark-extraction module 404 may also receive information from the prior map 408 and the GPR navigation filter 406 to identify locations of landmarks. A landmark-based navigation filter 412 may also use the landmarks identified by the landmark-extraction module 404 to provide a rough search pose to the GPR navigation filter 406 for additional refinement of positioning data. A sensor-fusion navigation filter 414 combines the output from the landmark-based navigation filter 412 with high-accuracy position information from the GPR navigation filter 406 and data from other sensor inputs 416 to generate a fused high-accuracy position of a tracking navigation filter for use in the system 108 in identifying the current location of the vehicle 102 of FIG. 1A. The fused high-accuracy position may be fed back to the GPR navigation filter 406 as an improved search pose to further refine the positioning determination.

The controller 208, the image-generation module 210, and the RF receiver module 212 implemented in the vehicle may include one or more modules implemented in hardware, software, or a combination of both. For embodiments in which the functions are provided as one or more software programs, the programs may be written in any of a number of high level languages such as PYTHON, FORTRAN, PASCAL, JAVA, C, C++, C#, BASIC, various scripting languages, and/or HTML. Additionally, the software can be implemented in an assembly language directed to the microprocessor resident on a target computer; for example, the software may be implemented in Intel 80x86 assembly language if it is configured to run on an IBM PC or PC clone. The software may be embodied on an article of manufacture including, but not limited to, a floppy disk, a jump drive, a hard disk, an optical disk, a magnetic tape, a PROM, an EPROM, EEPROM, field-programmable gate array, or CD-ROM. Embodiments using hardware circuitry may be implemented using, for example, one or more FPGA, CPLD or ASIC processors.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A navigation system, comprising:
a surface-penetrating radar (SPR) system comprising a ground-penetrating radar (GPR) antenna array configured to receive SPR signals and radio frequency (RF) signals;
an image-generation module for processing signals from the SPR system into images including subsurface features;
an RF reception module for extracting an RF signal from the SPR system; and
a navigation system for determining a location based at least in part on the RF signal, the images generated by the image-generation module, and at least one reference SPR image.

2. The system of claim 1, wherein the SPR system is configured to, if a location of the RF transmitter is known:
use a sensed power level of the extracted RF signal to estimate a distance from the RF transmitter; and
verify or correct a location that is estimated based on a GPR map.

3. The system of claim 1, wherein:
the GPR sensor array comprises a horizontal GPR sensor array comprising a plurality of antennas; and
the SPR system is configured to, if a location of the RF transmitter is not known:
monitor changes in a power level of the received RF signal over time as part of a map to estimate vehicle location; and
estimate a directional origin of the RF signal based on differences in arrival times across at least some of the plurality of antennas.

4. The system of claim 1, further comprising:
a radio antenna vertically displaced from the GPR antenna array,
wherein differences in arrival times across the GPR antenna array are used to estimate a horizontal direction with respect to a location of the RF transmitter, and
wherein differences in arrival times between the GPR antenna array and the radio antenna are used to estimate a vertical direction with respect to the location of the RF transmitter.

5. The system of claim 1, wherein the SPR system comprises a GPR system.

6. A navigation method comprising:
receiving SPR signals and radio frequency (RF) signals;
processing the SPR signals into images including subsurface features; and
determining a location based at least in part on the received RF signals, the images and a library of reference SPR images.

7. The method of claim 6, further comprising, if a location of the RF transmitter is known:
using the sensed power level of the received RF signals to estimate a distance from the RF transmitter; and
verifying or correcting a location that is estimated based on a GPR map.

8. The method of claim 6, further comprising, if a location of the RF transmitter is not known:
monitoring changes in a power level of the received RF signal over time as part of a map to estimate vehicle location; and
estimating a directional origin of the RF signal based on differences in arrival times.

9. The method of claim 6, further comprising:
estimating a horizontal direction with respect to a location of the RF transmitter based on differences in RF signal arrival times across a GPR antenna array; and
estimating a vertical direction with respect to the location of the RF transmitter based on differences in arrival times between the GPR antenna array and a radio antenna.

10. The method of claim 6, wherein the received RF signals are used to provide a coarse location estimate and the SPR signals are used to refine the coarse estimate.
